(19) United States
(12) Patent Application Publication
(10) Pub. No.: US 2011/0289986 A1
(43) Pub. Date: Dec. 1, 2011

(54) SELF-RESETTING INTELLIGENT ROTATING LOCK CYLINDER WITH POWER SUPPLY FROM KEY, ITS MATCHED LOCKSET AND KEY

(76) Inventors: Xiaoming Zhai, Yangzhou City (CN); Da Zhai, Yangzhou City (CN)

(21) Appl. No.: 13/147,849

(22) PCT Filed: Feb. 6, 2009
(86) PCT No.: PCT/CN09/70373

§ 371 Date: Aug. 4, 2011

(51) Int. Cl. E05B 47/06; E05B 73/00; E05B 47/00

(52) U.S. Cl. 70/58; 70/283.1; 70/276

(57) ABSTRACT

The present application relates to a self-resetting intelligent rotating lock cylinder device with power supply from a key, its matched lockset and the key. The self-resetting intelligent rotating lock cylinder device and the matched lockset include a keyhole unit and a turntable. An electronic circuit unit, an electromechanical drive unit and a force transmission clutch unit are provided on the turntable. A reset push pole that can reset the force transmission clutch unit is provided inside the keyhole. The electronic key includes a key head, contact points and an electronic circuit device. The electronic circuit device includes a power supply. Part of the out surface of the key head is wrapped with a metal sleeve. All contact points are exposed to the outer surface of the metal sleeve. By use of the intelligent rotating lock cylinder, its matched lockset and the key, existing mechanical locks can quickly upgraded to an electronic lock, and the safety and convenience of locksets in use are greatly improved. Many kinds of keys can be unified into one intelligent key, and the electronic lock can be widely used in hundreds of millions of families.

### FIELD OF TECHNOLOGY

The present invention relates to a lock.

### BACKGROUND

Now, electronic computer technology has been developing rapidly. All kinds of new electronic locks with the application of electronic computer technology have been invented and reported continuously. Although the invented electronic locks have come into being for many years and more convenient fingerprint locks have been invented now, they were only applied on doors of luxury hotels and a few high-grade offices, and had difficult in wide promoting and popularizing in homes and popular offices.

Although in the new electronic locks, many of the same kind of electronic keys may be unified into one key or one fingerprint, they are confined to be door locks only. In the new electronic locks, all keys of different kinds of electronic locks which include those applied on drawers, cabinets, luggage, equipment, etc., and are indispensible in the people's daily life, can be in no way unified into one key or one fingerprint.

The main reason why electronic locks (including fingerprint electronic locks) have difficult in promoting and popularizing in the majority of community homes and offices lies in the fact that the lock must be equipped with a power supply, which is mainly a battery. The existence of battery in the electronic lock results in the bulky volume of the electronic locks and difficult to be applied on drawers, cabinets, luggage, equipment, etc. that have special requirement for the volume of the lock; thus it is impossible to unify the keys of such miniature locks into one key or onto one finger. Meanwhile, the existence of the battery in the lock makes the battery replacing inconvenient. The time and way of replacing battery are very uncertain for different kinds of electronic locks. So, once the battery is not replaced in time because people are out for a long time or because they neglect or forget the replacing, or because cold weather makes too quick power consumption of the battery in the electronic lock to replace the battery in time or to give out an alarm. The breaking door or lock for unlocking is truly very unpleasant.

In order to overcome the above-mentioned shortcomings of electronic locks of prior arts, it is a creative idea to design and install the battery in the key rather than in the lock. In fact, according to the principle of unlocking, electronic locks, its main process is to identify an unlock password or unlocking authorization information, and to drive the motor or an electromagnet to operate an essential mechanical device to move a latch bolt of the lock. According to a circuit principle of the electronic lock, only when the key is inserted into the electronic lock, can the electronic circuits in the key and the lock constitute a complete circuit system. It matters little whether the battery is designed and installed in the electronic lock or in the key. But even so, when the battery is moved from the original electronic lock to the key, the main problem is how to reset the essential mechanical device in the state of unlocking lock when the key performed the unlocking and needs to be pulled out of the electronic lock. This is of great importance to the security and reliability of the electronic lock in use. And now the solution to this problem by electronic locks having no power supply of prior arts is to turn the key back before pulling it out of the electronic lock, to reset the essential mechanical device by rotating force of the turning back. However, this solution cannot assure the reliability and safety of the electronic lock resetting, and makes the lock structure complex and its big volume. Therefore this solution cannot be applied for more kinds of locksets. Therefore, up till now, such kind of electronic locks have not really been accepted by the market and the society.

The main problems the present invention intends to solve comprise:

(1) in the case that the electronic lock has no power supply, how to automatically and reliably reset the essential mechanical device of the electronic lock after the key unlocks the lock and pulls itself out of the keyhole;

(2) how to also realize electronic intelligence of other kinds of traditional locks than door locks.

(3) how to unify the structures and the basic operating principles of different kinds of locks including those applied for doors, drawers, cabinets, luggage, etc., so as to really open all kinds of locks with only one key and enable people to unify all kinds of their keys into only one key;

(4) how to solve the problems of the unified structure and mechanical strength of the key after unified into only one key and convenience of its use; and

(5) how to conveniently transform existing mechanical locks into intelligent electronic locks.

### SUMMARY

The purpose of the present invention is to overcome the above-mentioned shortcomings of the existing electronic locks and keys and provide an intelligent rotating lock cylinder with power supply from a key that can be reset by itself, a matched lockset and a key.

The technical schemes for solving the technical problem of the present invention are as follows:

A self-resetting intelligent rotating lock cylinder device with power supply from a key, comprising: a keyhole unit, including a keyhole and contact points; a turntable that turns together with the keyhole unit; an electronic circuit unit that is provided on the turntable and is electrically connected with the contact points; an electromechanical drive unit that is controlled by the electronic circuit unit; and a force transmission clutch unit that is driven by the electromechanical drive unit; a reset push pole is provided within the keyhole, and is pushed-in by a head of the key when the key is inserted into the keyhole; the force transmission clutch unit is reset to a non-transmission status when the key is pulled out of the keyhole; a first end of the reset push pole is provided in the keyhole, and a second end of the reset push pole passes through the keyhole and is provided on one side of the force transmission clutch unit.

In the above stated device, the second end of the reset push pole has a bent arm. In the above stated device, it further comprises a spring or magnets adapted to reset the reset push pole.

In the above stated device, the force transmission clutch unit comprises a lever that is adapted to be driven to move in different directions by the electromechanical drive unit and the reset push pole respectively.

In the above stated device, the electronic circuit unit comprises a real-time detection circuit that is adapted to detect the movement of the reset push pole at the time the key is inserted into the keyhole.

In the above stated device, the real-time detection circuit comprises a switch which is pushed by the reset push pole to operate.

In the above stated device, the real-time detection circuit comprises a capacitor.

In the above stated device, the contact points are provided on a first interior side of the keyhole; a movable cylinder is provided on a second interior side of the keyhole and is adapted to limit the key capable of being pulled out at a specific rotational position when the device is fixed into its outer case.

In the above stated device, positions of the contact points on the first interior side correspond to positions of contact points on USB interface of a general purpose computer.

A self-reset electronic lock with power supply from a key, comprising: an outer case, a lock latch and an intelligent rotating lock cylinder device as stated above.

In the above stated self-reset electronic lock, the lock latch device comprises: a drive block provided on the lock latch and a self-locking lever adapted to prevent the lock latch from sliding when it is locked; a step is provided on the outer case and is adapted to prevent the self-locking lever from sliding when the lock latch is locked.

A self-reset electronic lock head with power supply from a key, comprising: an outer case, a driven rotary device and an intelligent rotating lock cylinder device as stated above.

In the above stated self-reset electronic lock head, the driven rotary device comprises a driven turntable, a shaft sleeve and a dial wheel for force transmission outlet; one end of the shaft sleeve is fixed on the driven turntable and another end of the shaft sleeve is connected with the dial wheel for force transmission; and a drive block is provided on the driven turntable and is driven by the lever.

In the above stated self-reset electronic lock head, the driven rotary device comprises a cup cover served as a knob for indoor unlocking; and a manual switch adapted to prevent the key from unlocking is provided on the cup cover.

In the above stated self-reset electronic lock head, the manual switch comprises a lever; a magnet is provided on one end of the lever; and the electronic circuit unit comprises an electromagnetic switch device adapted to prevent the key from unlocking under the effect of the magnet.

In the above stated self-reset electronic lock head, the driven rotary device comprises a driven turntable provided inside the outer case; and a pole for force transmission outlet and a drive block driven by a lever are provided on the driven turntable.

An electronic key matched with a self-reset intelligent rotating lock cylinder device with power supply from the key and a matched lockset, comprising: a key head; contact points provided on the key head; an electronic circuit device electrically connected with the contact points; and an outer case; the electronic circuit device comprises a power supply; part of the outer surface of the key head is wrapped with a metal sleeve which is adapted to increase a push force of a reset push pole in a keyhole of the rotating lock cylinder device when the key head is inserted into the keyhole, and to strengthen a torque force of the rotating lock cylinder device; and all of the contact points are exposed to the outside of the metal sleeve.

In the above stated electronic key, a U-shaped gap is provided at one end of the metal sleeve; and all of the contact points are exposed within the U-shaped gap.

In the above stated electronic key, a through hole or a blind hole is provided on the key head.

In the above stated electronic key, positions of the contact points correspond to positions of contact points on USB interface of a general purpose computer.

In the above stated electronic key, the power supply is a chargeable battery.

The beneficial effects of the present invention are as follows:

The self-resetting manner of the reset push pole according to the present invention makes the electronic lock having no power supply safer and more reliable in use. The present invention can realize an electronic intelligentization of more kinds of traditional locksets other than door locks, thus greatly enhancing the security and convenience of these locksets in use. The present invention can unify the basic operating principles and structures of more kinds of locksets, thus unifying many kinds of keys into one key for the people. By replacing the same type of mechanical lock head with the electronic lock head of the present invention, the original mechanical lock can be immediately upgraded to an electronic lock. The arranging form of contacts on the key of the present invention corresponds to that of contacts on USB interface of a general purpose computer. Thus it is possible for the key for the electronic lock to get more technical and functional supports from general purpose computers.

### BRIEF DESCRIPTION OF DRAWINGS

The present invention will be described with reference to the drawings and embodiments.

FIG. 1 is a local sectional view of an embodiment of an electronic key of the present invention;

FIG. 2 is a side sectional view of FIG. 1.

FIG. 3 is a schematic circuit diagram of an embodiment of an electronic key of the present invention.

FIG. 4 is a side sectional view of an embodiment of the intelligent rotating lock cylinder of the present invention (i.e. A-A sectional view of FIG. 5).

FIG. 5 is a front view of an embodiment of the intelligent rotating lock cylinder of the present invention (a left view of FIG. 4).

FIG. 6 is a right view of FIG. 4 after removal of the electronic circuit 25.

FIG. 7 is a schematic circuit diagram of an embodiment of the intelligent rotating lock cylinder or the electronic lock or the electronic lock head of the present invention (the electromagnetic switching device W in the figure is connected or disconnected according to different situations).

FIG. 8 is a sectional schematic diagram of an embodiment of the intelligent rotating lock cylinder of the present invention in which the key is inserted into the keyhole 11 of the intelligent rotating lock cylinder; contact points 1 on the key just touch contact points 14 of the electronic lock; and the reset push pole 29 has not yet pushed the switch 24.

FIG. 9 is a sectional schematic diagram of an embodiment of the intelligent rotating lock cylinder of the present invention in which the key is fully inserted into the keyhole 11 of the intelligent rotating lock cylinder; and the electromagnetic drive device 27 drives the lever 22 to make it in a force transmission state.

FIG. 10 is a right view of FIG. 9.

FIG. 11 is a local schematic diagram of FIG. 4 in which the spring 17 is substituted with magnets 38 and 39.

FIG. 12 is a side local sectional view showing a structural portion between the movable cylinder 31 in the keyhole 11 and the outer case 40 after the intelligent rotating lock cylinder is applied to an electronic lock or an electronic lock head according to an embodiment of the present invention.

FIG. 13 is a B-B sectional view of FIG. 12.

FIG. 14 is a schematic diagram of a state after the key shown in FIG. 13 is turned.

FIG. 15 is a side sectional view of an embodiment of the electronic lock of the present invention.

FIG. 16 is a right view of FIG. 15 after the removal of a rear cover 49 and an electronic circuit device 25 of the electronic lock.

FIG. 17 is a schematic diagram of a state in which the electromagnetic drive device 27 drives a lever 22 to be in a force transmission state; and the reset push pole 29 pushes a switch 24 when the key is inserted into the keyhole 11 of the electronic lock, according to an embodiment the present invention.

FIG. 18 is a right view of FIG. 17 after the removal of the rear cover 49 and the electronic circuit device 25 of the electronic lock.

FIG. 19 is a schematic diagram showing a state in which a lever 22 pushes a lever 43 to apply a transmission force onto a drive block 45 when a key is turned to unlock the electronic lock according to an embodiment.

FIG. 20 is a schematic diagram showing that the latch bolt 42 of the lock in FIG. 19 is driven to be in place by unlocking operation.

FIG. 21 is a schematic diagram showing that the key is turned to lock the latch bolt 42 after the latch bolt is unlocked according to an embodiment of the present invention.

FIG. 22 is a schematic diagram showing that the latch bolt 42 in FIG. 21 is driven to be in place by locking operation.

FIG. 23 is a side sectional view of the electronic lock head according to one embodiment of the present invention, i.e. C-C sectional view in FIG. 24).

FIG. 24 is a front view of the electronic lock head according to one embodiment of the present invention, i.e. a left view of FIG. 23.

FIG. 25 is a right view of FIG. 23.

FIG. 26 is a local sectional view of a latch bolt of the lock (commonly known as “a lock body”) which is on the market and is matched with the lock head of the present invention.

FIG. 27 is a D-D sectional view of FIG. 23.

FIG. 28 is a sectional schematic diagram showing that when the key is inserted into the keyhole 11, the electromechanical drive device 27 drives the lever 22 to be in a force transmission state, so as to allow the key to be turned to lock or unlock, in one embodiment of the electronic lock head of the present invention.

FIG. 29 is a side sectional view of a second embodiment of the electronic lock head of the present invention, i.e. E-E sectional view of FIG. 30.

FIG. 30 is a front view of the second embodiment of the electronic lock head of the present invention, i.e. a left view of FIG. 29.

FIG. 31 is a right sectional view of FIG. 29.

FIG. 32 is a sectional schematic diagram showing that when a lever 78 of a hand-driving switch is turned on, the electromechanical drive device 27 cannot drive the lever 22 to perform unlocking, even if the key is inserted into the keyhole 11, in the second embodiment of the electronic lock head of the present invention.

FIG. 33 is a schematic diagram of local sectional view of a latch bolt of the lock (commonly known as “a lock body”) which is on the market and is matched with the second embodiment of the electronic lock head of the present invention.

FIG. 34 is a left view of FIG. 33.

FIG. 35 is a sectional schematic diagram showing that when the hand-driving switch is turned off and the key is inserted into the keyhole 11, the electromechanical drive device drives the lever 22 to be in a force transmission state, and the reset push pole 29 pushes the switch 24, in the second embodiment of the electronic lock head of the present invention.

FIG. 36 is F-F sectional view of FIG. 29.

FIG. 37 is G-G sectional view of FIG. 35.

### DETAILED DESCRIPTION

Embodiment of the key of the present invention:

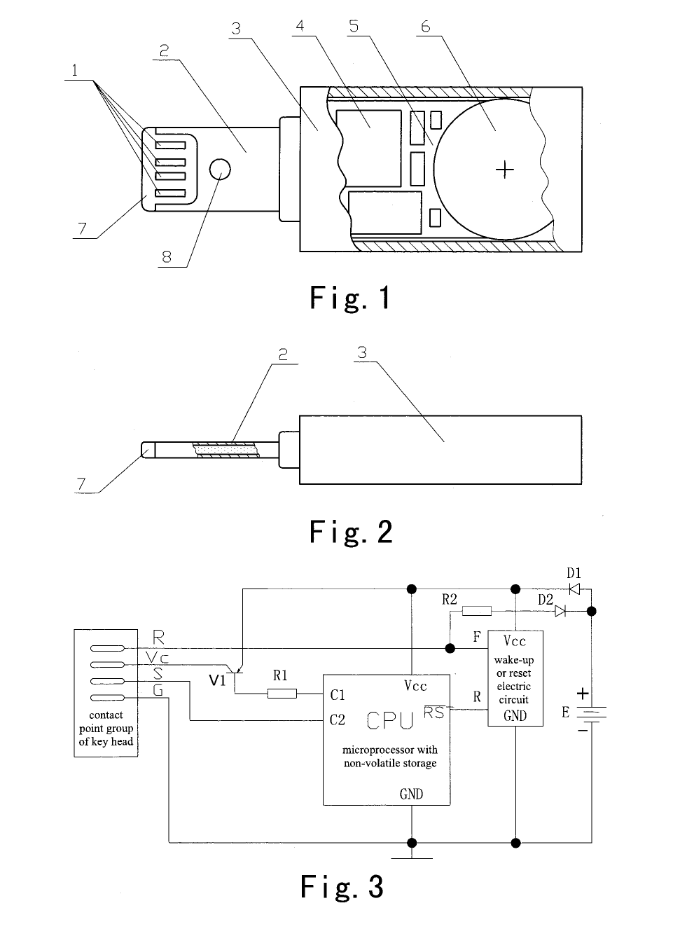

The structure of the key of this embodiment is as shown in FIG. 1 and FIG. 2. FIG. 2 is a local side sectional view of FIG. 1. In FIG. 1, key head 7 on the left end consists of metal sleeve 2, contact points 1 and insulating materials. Metal sleeve 2 wraps the outer surface of a root part of key head 7. The metal sleeve 2 has a U-shaped gap on one end facing key head 7. The purpose of designing such a metal sleeve 2 is to enhance the mechanical strength of key head 7. When key head 7 is inserted into keyhole 11 of the rotating lock cylinder device, the metal sleeve 2 is adapted to strengthen the pushing force of the reset push pole 29 in keyhole 11 and enhance the torque force of the rotating lock cylinder device. Within the U-shaped gap of metal sleeve 2, a contact point group is provided to be exposed in the U-shaped gap. The surrounding part of each contact point is filled with insulating materials. The contact point group is provided on one face of key head 7. The U-shaped gap of metal sleeve 2 also exists on another face of key head 7 having no contact points. The U-shaped gap of metal sleeve 2 on the another face is made of insulating material. The outer surfaces of contact points 1 and the insulating material are substantially coplanar to the outer surface of metal sleeve 2. The positions of contact points 1 on key head 7 correspond one by one with those of contact points on international standard USB interface socket of a general purpose computer, respectively. In other words, the mechanical size of key head 7 and positions of contact points 1 are matched with the international standard USB interface socket. Thus, the key according to the present invention can get more technical and functional supports from the general purpose computer. Structure definitions of USB interface socket were prescribed and published by relevant international industry organizations. In order to prevent the key of the present invention from being pulled out unintentionally when turning it to unlock, a hole 8 is provided on key head 7, as shown FIG. 1. The hole 8 may be a through hole or a blind hole (commonly known as “a concave pit”), and will be illustrated in an embodiment of the intelligent rotating lock cylinder device below.

The outer case 3 is at right ends of FIGS. 1 and 2. An electronic circuit device 5 is within the outer case 3, is connected with contact points 1 through wires, and comprises a power supply 6, which it is a battery in the figure, and CPU 4 with nonvolatile storage. The nonvolatile storage of CPU 4 stores a unique password representing each key. FIG. 3 is a schematic circuit diagram of the key according to an embodiment of the present invention. In the contact point group of the key head as shown in FIG. 3, R indicates a wake-up or reset end; VC indicates a controllable output end of power supply; S indicates a two-way serial signal communication end; and G indicates a common earth terminal. FIG. 7 is a schematic circuit diagram of the intelligent rotating lock cylinder device or the electronic lock or the electronic lock head according to embodiments of the present invention. In FIG. 7, CPU is a microprocessor with non-volatile storage, and stores in advance a password of a key allowed to unlock. In the contact point group of the keyhole, R end is adapted to provide wake-up or reset signal to the key; VC is an outputting end of power supply; and S end and G end perform the same function as the key does. When the key is inserted into the keyhole as is shown in FIG. 7, the contact points of R, VC, S and G of the key head in FIG. 3 are connected with corresponding contact points of R, VC, S and G in the keyhole of FIG. 7, respectively. And so, F end of the wake-up or reset circuit of the key will get a short and low level signal generated by capacitor C in FIG. 7. In the wake-up or reset electric circuit, a pull-up resistor between F end and VCC end keeps a usual high level of F end. When F end of the wake-up or reset electric circuit of the key gets the low level signal, R end of the wake-up or reset electric circuit will output a low level to make CPU of the key wake up or reset. When CPU of the key is waken up or reset, C1 end on CPU of the key shall turn from a high level to a low level which turns transistor V1 on through Resistor R1. And so, a battery E supplies power to the electric circuit of FIG. 7 through diode D1, transistor V1 and contact point VC. After the electric circuit in FIG. 7 is powered, it will first ask for a password from the electronic key through the signal line (i.e. S end of the contact points). After the Key gets the instruction to ask for a password, it will give a reply of the password of the key through the signal line (i.e. the S end of the contact points) to the electric circuit of FIG. 7. After obtaining the password from the key, the electric circuit of FIG. 7 will determine whether the obtained password is consistent with that stored in the electric circuit of FIG. 7. If the obtained password is correct, CPU of FIG. 7 will drive a motor M to rotate for unlocking the lock.

In FIG. 3, the battery E may be designed as a common button-shaped battery or rechargeable battery. If the battery E is un-chargeable, R2 and D2 in FIG. 3 are unnecessary. If the battery E is chargeable, R2 and D2 shall be connected. In this way, the key of the embodiment may be inserted into the USB port of a general purpose computer; and battery E may be charged by using the power supply from USB port.

Embodiment of the intelligent rotating lock cylinder device of the present invention:

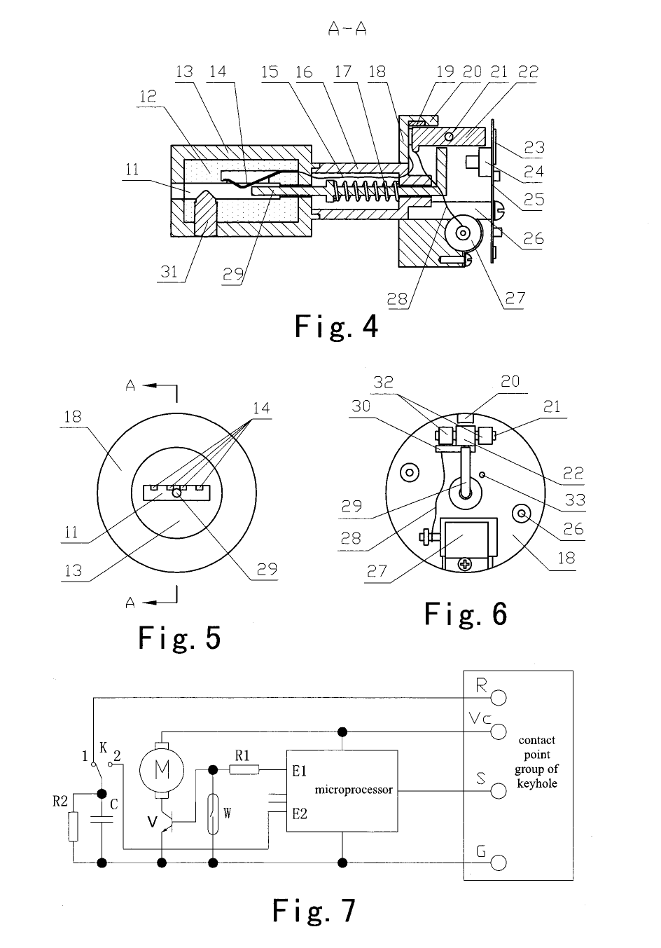

FIG. 4 is a side sectional view of the lock cylinder device of this embodiment (i.e. the sectional view along the A-A line in FIG. 5). FIG. 5 is the front view of this lock cylinder device (i.e. the left view of FIG. 4). FIG. 6 is the right view of FIG. 4 after the removal of the electric circuit device 25. In FIG. 4, the keyhole unit comprises cylinder 13, insulating material 12, contact points 14 and movable cylinder 31. A keyhole 11 with a flat rectangular cross-section is on the axle line of the keyhole unit. The insulating material 12 is filled in the empty chamber of cylinder 13 and is around the keyhole 11. The end parts of contact points 14 are embedded into the insulating material 12. The rest parts of the contact points 14 are exposed to keyhole 11. As shown in FIG. 5, contact points 14 in this embodiment include four contact points, which are provided on one interior side of keyhole 11. The position of each of contact points 14 corresponds with the position of each contact point on USB interface socket of the general purpose computer. The reset push pole 29 is provided in keyhole 11.

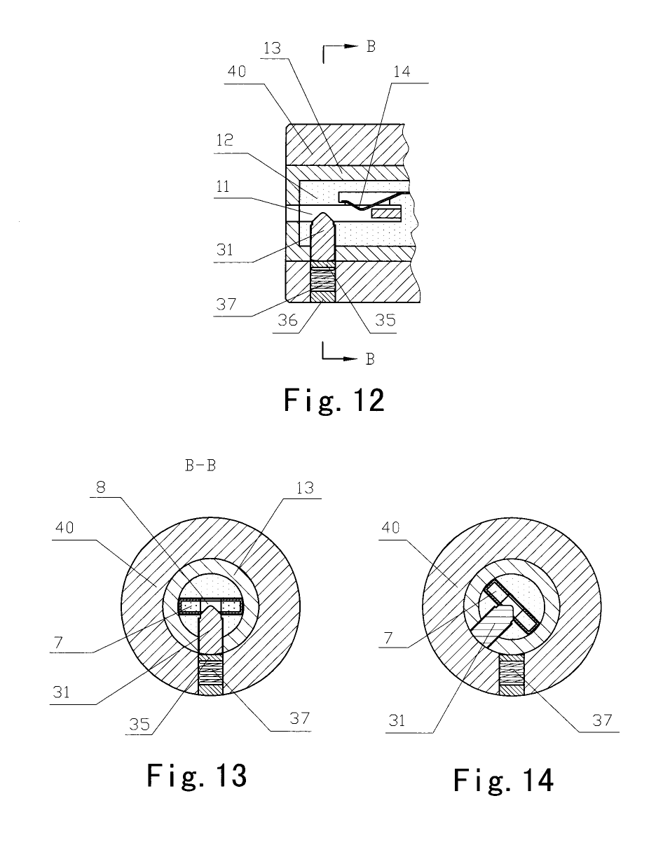

On the opposite side of the contact points of keyhole 11, a through hole passes through the insulating material 12 and the cylinder 13. In the hole is the movable cylinder 31 that can limit the key to be pulled out at a specific rotational position when the intelligent rotating lock cylinder device of the embodiment is fitted into the outer case of an electronic lock or an electronic lock head. As shown in FIG. 12, when the intelligent rotating lock cylinder device of this embodiment is fitted into the outer case 40 of an electronic lock or lock head, it matches with a through hole which is concentric with movable cylinder 31 and below the outer case 40 to allow the cylinder 31 movable. Slide block 35, spring 37 and stopper 36 are installed inside this through hole. Stopper 36 is put tightly onto the outer case 40 so that the lower end of spring 37 cannot be moved easily. The upper end of spring 37 pushes up the slide block 35 and further pushes up movable cylinder 31. So, a conical head at the end of movable cylinder 31 is pushed up into keyhole 11. After the intelligent rotating lock cylinder device is fitted into the outer case 40, it can rotate along with the inserted key head 7 in the empty chamber of the outer case 40. When the intelligent rotating lock cylinder device is located in an normal position in the outer case 40 as shown in FIG. 12, the through hole with fitted movable cylinder 31 in the intelligent rotating lock cylinder device is on the same straight line as the central line of the through hole below the outer case 40. At this moment, when lock head 7 is inserted into the keyhole 11 as is shown in FIG. 12 or 13 (FIG. 13 is the sectional view of B-B line in FIG. 12), the head part of lock head 7 pushes the movable cylinder 31 through the force of its cant and presses slide block 35 and spring 37 to move downward. When lock head 7 is fully inserted, the head part of the movable cylinder 31 falls into hole 8 of the lock head 7, and the intersecting surface of the lower end of the movable cylinder 31 with the slide block 35 is just on the curved intersecting surface of cylinder 13 with the interior chamber of the outer case 40. At this moment, if the key is turned, the movable cylinder 31 can be driven to rotate with cylinder 13 of the intelligent rotating lock cylinder device, however, if the lock head 7 is pulled out at this moment, since the central lines of the through hole of the movable cylinder 31 and the through hole below the outer case 40 are not on the same straight line, the movable cylinder 31 cannot be escaped from hole 8 of the key head 7 to slide, and lock head 7 cannot be pulled out from the non-normal position (as shown in FIG. 14), thus the electric contact between the key and the lock or the lock head when turning the key is ensured. Because of the actions of hole 8 on the lock head and the movable cylinder 31, lock head 7 cannot be inserted or pulled out unless the intelligent rotating Jock cylinder device is on the normal position as shown in FIG. 13.

It can be seen from FIG. 4 that a right end of the keyhole unit is connected with a cylinder 16 with the torque transfer function, which may be lengthened or shortened in accordance with the practical applications of this intelligent rotating lock cylinder device, and the other end of cylinder 16 is connected to a round turntable 18. An electromechanical drive device 27 is provided on turntable 18, and comprises a motor and a thin wire 28 with pulling effect. One end of the thin wire 28 is fixed on one end of the motor shaft. When the motor rotates, thin wire 28 is wound onto the motor shaft to play a pulling role. Certainly, in this embodiment, the motor may be replaced with a magnet. A force transmission clutch unit is provided on the turntable 18, its major function is to transmit controllably the rotating torque force of the intelligent rotating lock cylinder device to other devices or parts. In fact, it is a controllable force transmission clutch unit with two statuses of “engaged” or “disengaged”. The disengaged status is a non-transmission state, and the engaged status is a transmission state. The force transmission clutch unit comprises lever 22, lever shaft 21 and bracket 32. It can be seen from FIGS. 4 and 6 that lever 22 rotates around lever shaft 21. The central axle line of lever shaft 21 is parallel with the surface of turntable 18. Lever shaft 21 is mounted on the lever bracket 32. Two lever brackets 32 and a part of the surface of turntable 18 form a U-shaped bracket. Lever 22 moves within the U-shaped bracket. The main part of lever 22 is a steel square cylinder with shaft holes in its central portion. A steel wire 30 is provided on one end of this square steel cylinder, and they form a whole. The central axle line of this steel wire 30 is parallel with the central line of the shaft hole of lever 22. This steel wire forms an “L” shape with the square cylinder (See FIGS. 6 and 10). The other end of the thin wire 28 that is fixed to the shaft end of the motor is fixed to the steel wire 30. A force arm of one end of lever 22 on which level 22 has the steel wire 30 is a power arm, and the other end is a resistance arm. When lever 22 is located in the positions as shown in FIG. 4 and FIG. 6, the magnet 19 installed on the limit stopper 20 attracts the power arm of lever 22 and makes lever 22 stay steadily in a position perpendicular to the surface of turntable 18. Under such circumstances, lever 22 or the force transmission clutch unit is in non-transmission state. If the motor rotates at this moment, it will pull the steel wire 30 on the lever 22 through thin wire 28 and further revolve lever 22 to the parallel position between lever 22 and the surface of turntable 18 as shown in FIGS. 9 and 10. When lever 22 is parallel with the surface of turntable18, lever 22 or the force transmission clutch unit is in an “engaged” state of force transmission (i.e. in a force transmission state). Since the end part of the resistance arm of lever 22 is extended out of the circumfrence of the contour line of turntable 18 at this position, the rotating of the intelligent rotating lock cylinder device of the present invention at this time can transmit the rotating force to the other devices or components through the resisting arm of lever 22. The limit stopper 20 in this embodiment plays a role of limiting the movement scope of lever 22.

It can be seen from FIG. 4 that reset push pole 29 is installed inside keyhole 11. When the key is inserted into keyhole 11, it will push the key head 7 forward, and when the key is pulled out of keyhole 11, it will reset the force transmission clutch unit to non-transmission state. This reset push pole 29 is thin and long in shape. One of its ends is provided in keyhole 11; and the other end passes through keyhole 11 and cylinder 16 to one side of the force transmission clutch unit. The end part of reset push pole 29 provided at one side of the force transmission clutch unit has an “L” shaped bent arm. It can be seen from FIG. 4 that reset spring 17 circles around the middle part of reset push pole 29. Reset spring 17 always pushes reset push pole 29 in the direction of pulling out the key. When key head 7 is inserted into keyhole 11 (as shown in FIG. 9), spring 17 is compressed, and the space between the bent arm on the right end of reset push pole 29 and the surface of turntable 18 is open, thus allowing lever 22 to be driven by a motor to move to be in the transmission state as shown in FIG. 9. When key head 7 is pulled out of keyhole 11, reset push pole 29 is pushed by spring 17 to move in the direction of pulling out the key. So the end part of the bent arm of reset push pole 29 forces lever 22 to move to be in the non-transmission state as shown in FIG. 4, thus completing the reset of lever 22 or the force transmission clutch unit. In this embodiment, the installation position of spring 17 is flexible and variable. For example, it may be installed at the bent arm of reset push pole 29, making one end of spring 17 press against the circuit board of the electronic circuit device 25 and the other end press against the bent arm of reset push pole 29. Its effect is the same as the aforesaid effect. In this embodiment, spring 17 may also be replaced with two magnets 38 and 39 as shown in FIG. 11. Magnet 38 is fixed on the circuit board of electronic circuit device 25. The magnet 39 is fixed at the bent arm of the reset push pole 29. Magnets 38 and 39 are installed with the same magnetic poles putting together to produce a repulsive magnetic field. This will produce the same effect as the aforesaid one.

In this embodiment, the electronic circuit device 25 includes a printed circuit board on which a microprocessor (CPU) 23 and other electronic components are mounted, as shown in FIG. 4. The electronic circuit device 25 is fixed on a fixed leg 26 of turntable 18, is electrically connected through a wire with electromechanical drive device 27 and with contact points 14 in the keyhole unit through wire 15. An outlet hole 33 for wire 15 is provided on turntable 18. An electronic circuit system of this embodiment is shown in FIG. 7. Transistor V, resistor R1 and E1 end of CPU constitute a control switch of the electromechanical drive device 27 (it is motor in this embodiment). When a level of E1 end of CPU is changed from a low level to a high level, transistor V is switched on to make the motor revolve. In FIG. 7, W is an electromagnetic switch device, which will make the base pole of transistor V shortcut under the effect of a magnetic field, thus ensuring the stop of the motor to prevent unlocking of the lock under special circumstances. In this embodiment, W is a reed switch (it may be replaced with Hall electronic switch), and may be introduced or removed according to practical applications of the intelligent rotating lock cylinder device of the present invention in electronic locks or electronic lock heads. In the embodiment of FIG. 7, SPDT (Single Pole Double Throw) push button switch K, capacitor C, resistor R2 and contract points R constitute a real-time detection circuit for detecting whether reset push pole 29 is pushed to move when the key is inserted into the keyhole. The detecting circuit is used to prevent the reset push pole 29 from being maliciously pushed inward, thus avoiding insecurity of the lock in use. Capacitor C is used to store charge voltage. Resistor R2 is used to discharge. Switch K is installed on the circuit board of the electronic circuit device 25 (see Switch 24 in FIG. 4). When key head 7 is fully inserted into keyhole 11, reset push pole 29 reaches the utmost right position. So, the bent arm on the right end of reset push pole 29 pushes down the button of switch 24 (see FIG. 9), thus making capacitor C turn from the connection with the original contact points 1 of switch 24 to the connection with contact points 2 of switch 24 (See FIG. 7).

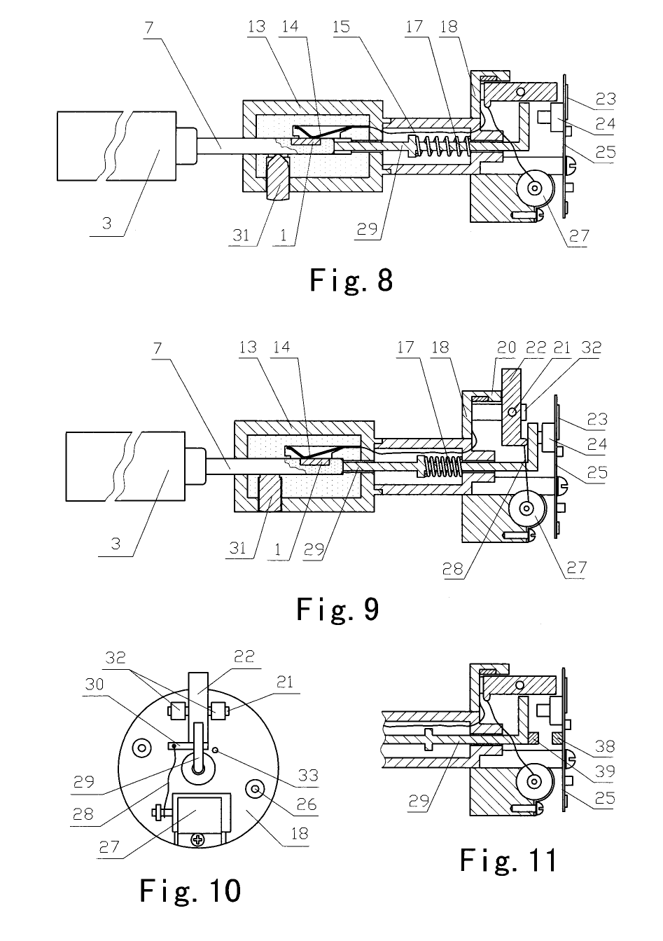

In the course of inserting the key as shown in FIG. 3 into the keyhole 11 of the intelligent rotating lock cylinder device of the embodiment as shown in FIG. 7, when switch 24 has not been pressed to switch over by reset push pole 29 (as shown in FIG. 8), contact points R, VC, S and G on key head 7 have been respectively connected with corresponding contact points R, VC, S and G in the keyhole in FIG. 7. Since switch 24 is not pressed down at this moment, capacitor C is still connected with contact points 1 of switch 24. So capacitor C is quickly charged. In the interior of the wake-up or reset circuit of the key, a pull-up resistor between F end and VCC end makes F end always remain at high level), and capacitor C provides a short and low level signal to F end of the wake-up or reset circuit of the key at the moment capacitor C starts being charged. As a result, the R end of the wake-up or reset circuit of the key outputs a low level to wake up or reset CPU of the key. After CPU of the key is waken up or reset, a lever of C1 end of CPU is changed from a high level to a low level, which makes transistor V1 turn on through resistor R1. In this way, battery E supplies power to the circuit of FIG. 7 through diode D1, transistor V1 and contact point VC. After the circuit of FIG. 7 is powered, it will first ask for a password from the electronic key through the signal line (i.e. S end of contact points). After the key gets inquiry instruction for password, it will give an answer of the password stored in advance in the key to the circuit of FIG. 7 through the signal line (i.e. S end of contact points). After the circuit of FIG. 7 obtains the answer of password from the key, it will judge whether the obtained password is consistent with the password of the key stored in advance in the microprocessor (CPU) of FIG. 7. At the same time, the CPU in FIG. 7 waits for a short moment (waiting for reset push pole 29 to be pushed in place to press against switch 24), and then judges whether port E2 connecting it with capacitor C is at a high level (adjusting the parameter of capacitor C to make it being fully charged before switch 24 is pressed down). Only when the key answers the password correctly and port E2 of CPU is at a high level, CPU in FIG. 7 will drive motor M to revolve to unlock the lock (as shown in FIG. 9). If the reset push pole 29 is maliciously pushed in and blocked in advance, before the key is inserted into keyhole 11, switch 24 is pressed in advance by reset push pole 29, to disconnect capacitor C with contact point 1 of switch 24. So when the key is inserted into keyhole 11, capacitor C will not be charged. As a result, in the course of unlocking with the key, even if the key answers the correct password, however capacity C has not got a high level, CPC in FIG. 7 will not drive motor M to revolve, thus ensuring safe use of the lockset. Otherwise, if the motor is allowed to revolve to unlock the lockset at this moment, the reset push pole maliciously blocked in advance cannot reset the lever 22 after the key is pulled out. As a result, this lock becomes unsafe. Therefore, the real-time detection circuit is of great importance and ensures the safety of the lockset in this embodiment.

Embodiment of an electronic lock of the present invention:

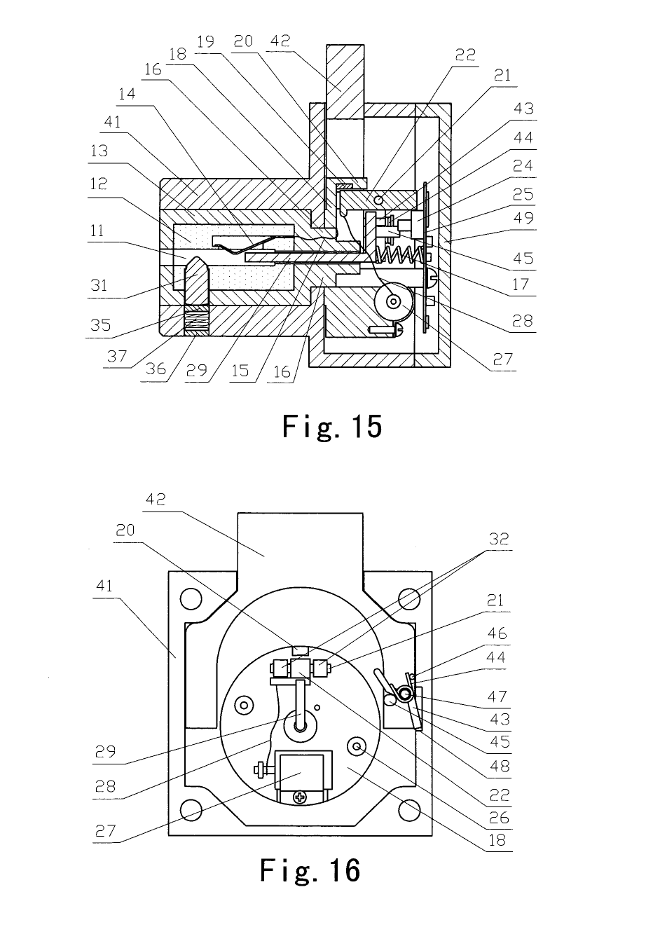

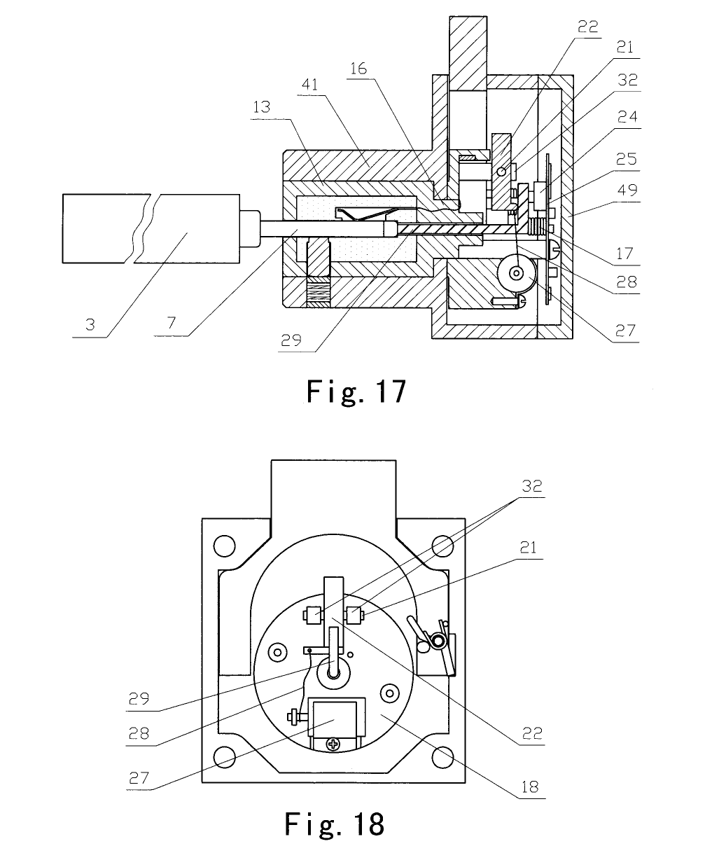

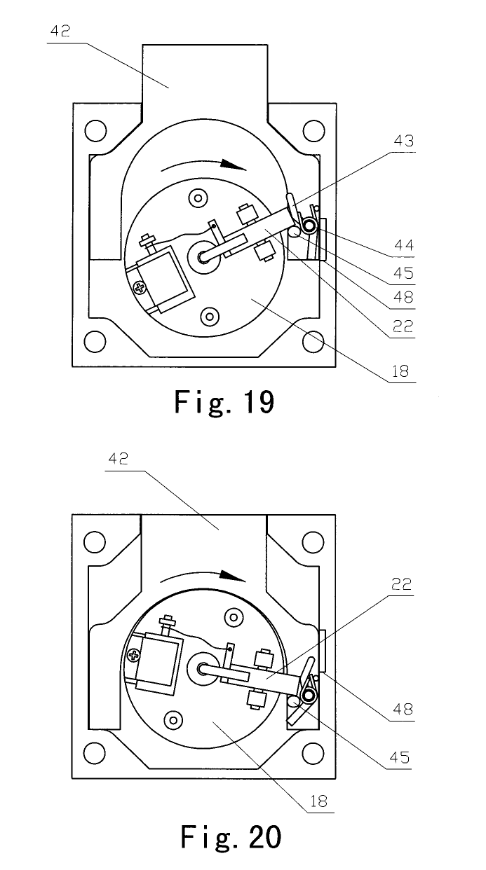

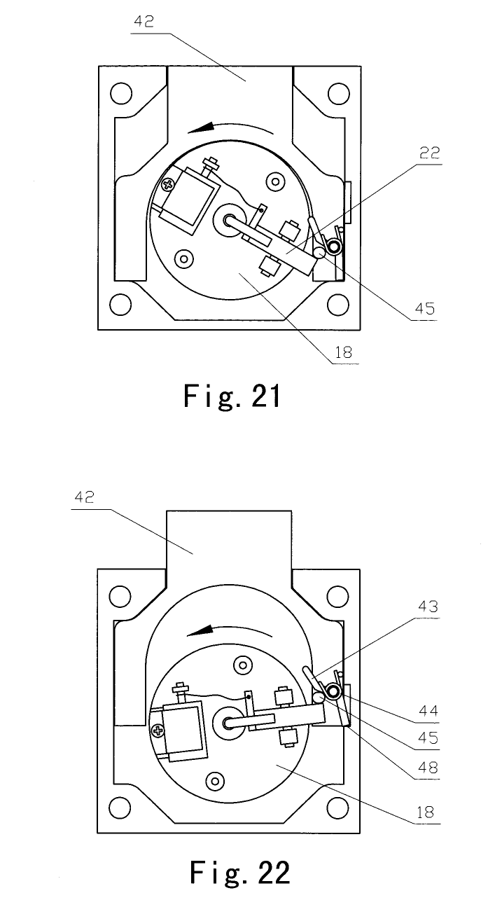

FIG. 15 is a side sectional view of the intelligent rotating lock cylinder device of this embodiment in which the above-mentioned intelligent rotating lock cylinder device is applied to a drawer or a cabinet. FIG. 16 is a right view of FIG. 15 after removal of the rear cover 49 of the electronic lock and the electronic circuit device 25. In FIGS. 15 and 16, the above-mentioned intelligent rotating lock cylinder device of this embodiment and a lock latch bolt device that can slide up and down in outer case 41 are installed in the empty chamber of the outer case 41 and the rear cover 49 of the electronic lock. Cylinder 16 in the intelligent rotating lock cylinder device is shortened and incorporated with the keyhole unit. Spring 17 is moved and installed at the bent arm of the reset push pole 29. At the same time, the electromagnetic switch device W in FIG. 7 is removed. The lock latch bolt device comprises a lock latch bolt 42 whose lower part is horseshoe shaped, drive block 45 provided on lock latch bolt 42, and self-lock lever 43 that prevents the lock latch bolt 42 from sliding after being locked. In FIG. 16, a helical torsion spring 44 is provided on the self-locking lever 43 and acts on the self-locking lever 43. This helical torsion spring 44 always tries to turn the self-locking lever 43 in a counter-clockwise in the figure. One arm of a helical torsion spring 44 acts on stopper block 46. Another arm of helical torsion spring 44 acts on the upper arm of the self-locking lever 43. The self-locking lever 43 has a shaft holes at its middle part. Shaft 47 passes through and integrate with helical torsion spring 44 and self-locking lever 43, which are installed on the lock latch bolt 42. A step 48 is provided on the outer case 41 and can prevent the self-locking lever 43 from sliding when the lock latch bolt 42 is locked. When lock latch bolt 42 or the lock latch bolt device is located in the locked position as shown in FIG. 16, the lower arm of the self-locking lever 43 rotated around a shaft 47 is located on the step 48 of the outer case 41, thus ensuring the lock latch bolt 42 not to slide in the direction of unlocking the lock. When the key is inserted into the electronic lock of the embodiment to unlock it, capacitor C in FIG. 7 is charged, reset push pole 29 is pushed forward by key head 7, spring 17 is compressed, switch 24 is pressed to switch, and the CPU in the lock controls the motor to revolve after verifying that the answer to the password from the key is correct and capacitor C is at a high level. In this way, lever 22 or force transmission clutch device is driven to be in force transmission state (as shown in FIGS. 17 and 18). At this time, the key is turned in the direction indicated by the arrow in FIG. 19. The end of lever 22 that revolves together with the key and turntable 18 will first push away the upper arm of the self-locking lever 43 on the lock latch bolt 42. As a result, the self-locking lever 43 rotates around shaft 47 to further push the lower arm end of the self-locking lever 43 away from step 48 on the outer case 41. Then, the end part of lever 22 transmits the rotating force to the drive block 45, to make the lock latch bolt 42 slide in the direction of unlocking the lock. The key is continuously turned, until the lock latch bolt 42 is completely locked (as shown in FIG. 20). After the lock latch bolt 42 is unlocked and the key is pulled out, as stated in the previous embodiment, reset push pole 29 will reset lever 22. Under such circumstances, one key that can unlock the lock is inserted once again, and lever 22 will be driven to be in force transmission state once again. At this time, if the key is turned in the directions of the arrows shown in FIGS. 21 and 22, the end part of lever 22 exerts force on drive block 45 in another direction. The key is continually turned until the lock latch bolt 42 is moved to a locking position. When the lock latch bolt 42 reaches the locking position, the lower arm end of the self-locking lever 43 will tightly button up the step 48 of the outer case 41 under the action of helical torsion spring 44, thus realizing safe locking of the lock latch bolt 42.

In this embodiment, because of the action of the movable cylinder 31 on the above-mentioned intelligent rotating lock cylinder device and the slide block 35, spring 37 and stopper 36 on the outer case 41, the key can be inserted into or pulled out of the keyhole only at the position of turntable 18 as shown in FIGS. 15 and 16, thus avoiding the interference with movement of lever 22, which is generated by parts on the lock latch bolt device.

### First Embodiment of the Electronic Lock Head of the Present Invention

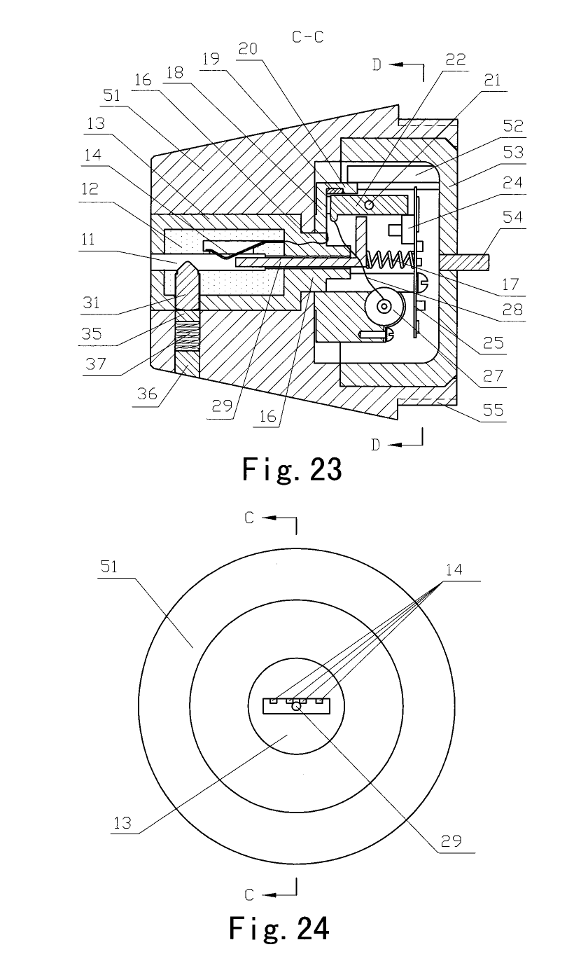

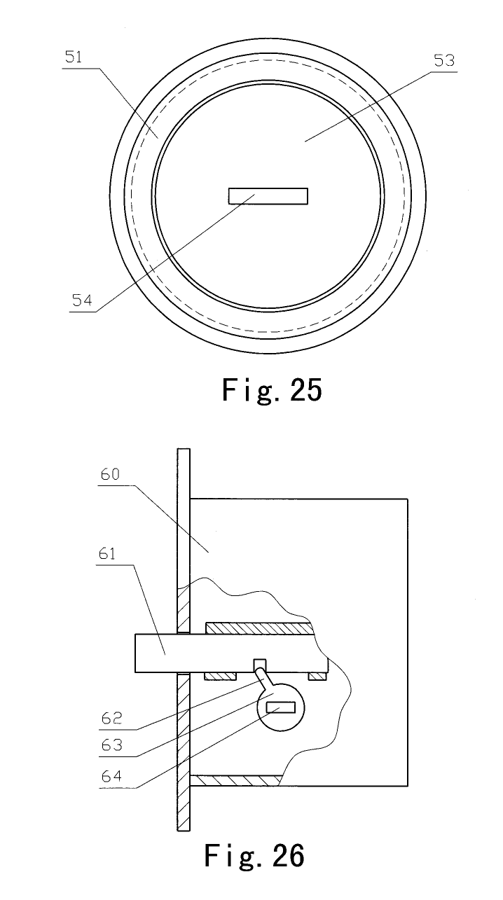

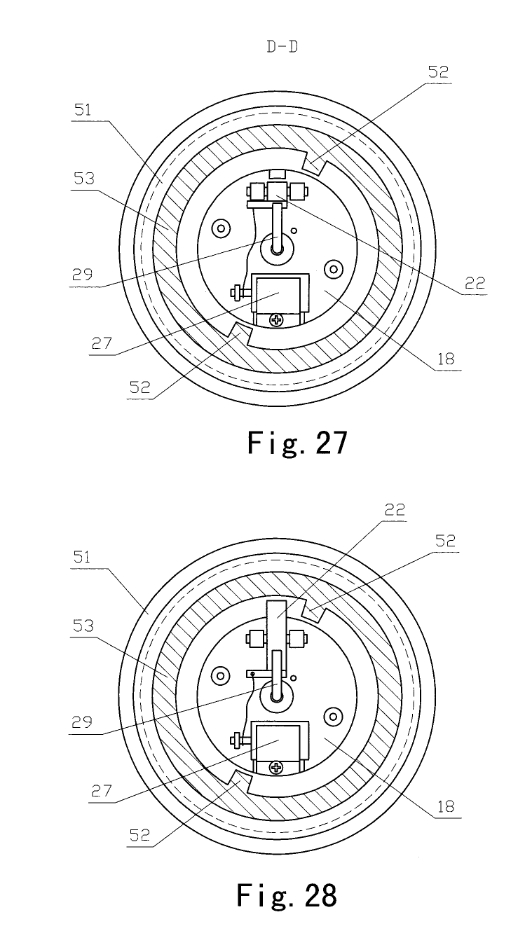

FIG. 23 is a side sectional view of the electronic lock head of this embodiment (i.e. C-C sectional view of FIG. 24). FIG. 24 is a front view of the electronic lock head of this embodiment and also a left view of FIG. 23. FIG. 25 is a right view of FIG. 23. In FIG. 23, the aforesaid intelligent rotating lock cylinder device of the aforesaid embodiment and a driven rotating device rotatable in outer case 51 are installed in an empty chamber of the outer case 51 of the lock head. Cylinder 16 in the intelligent rotating lock cylinder device is shortened and incorporated with the keyhole unit. Spring 17 is moved and installed at the bent arm of reset push pole 29. At the same time the electromagnetic switch device W in FIG. 7 is removed away. The driven rotating device comprises a driven turntable 53 which is installed in the outer case 51 and is a bowel-shaped rotator with its outside center equipped with a force transmission outlet pole 54. The force transmission outlet pole 54 is cylinder-shaped, is adapted mainly to transmit torque force, and has a cross-section which may be various non-circular shapes (it is a leaf-shaped flat rectangular in this embodiment). A drive block 52 driven by lever 22 is installed on the inside edge of the driven turntable 53 (See FIG. 27, the D-D sectional view of FIG. 23). FIG. 26 is a local sectional view of the lock latch bolt structure (commonly known as “a lock body”) which is on the market and matches with the electronic lock head of this embodiment. In this embodiment, the lock head is fixed on the lock latch bolt structure through screw thread 55 on the outer case 51, and the force transmission outlet pole 54 is inserted into its torque force transmission hole 64 when fixing it. The torque force transmission hole 64 is located in the center of dial wheel 63 for moving the lock latch bolt. A dial tooth 62 is provided on dial wheel 63. When the force transmission outlet pole 54 in this embodiment revolves and drives dial wheel 63 to turn, the lock latch bolt 61 in the outer case 60 will perform unlocking or locking with the movement of the dial tooth 62.

FIG. 27 is a D-D sectional view in FIG. 23. FIG. 28 is a schematic sectional view of the lock head showing that when a key is inserted into the keyhole 11 and electromechanical drive device 27 drives lever 22 to be in the force transmission state to turn the key, to perform unlocking or locking. In FIG. 28, lever 22 transmits the torque force for turning the key to driven turntable 53 through drive block 52, thus driving the force transmission output pole 54 in FIG. 23 and the dial wheel 63 in FIG. 26 to turn together, to realize unlocking or locking with the lock latch bolt 61.

In this embodiment, because of the action of the movable cylinder 31 in the above-mentioned intelligent rotating lock cylinder device, and the slide block 35, spring 37 and stopper 36 on the outer case 51, the key can be inserted into or pulled out of the keyhole only when turntable 18 is at the positions as indicated in FIGS. 23 and 27, thus avoiding the interference with movement of lever 22 from drive block 52 on driven turntable 53.

By replacing a mechanical lock head of a mechanical lock with the same type of electronic lock of this embodiment, the mechanical lock will be immediately upgraded to an electronic lock.

### Second Embodiment of the Electronic Lock Head of the Present Invention

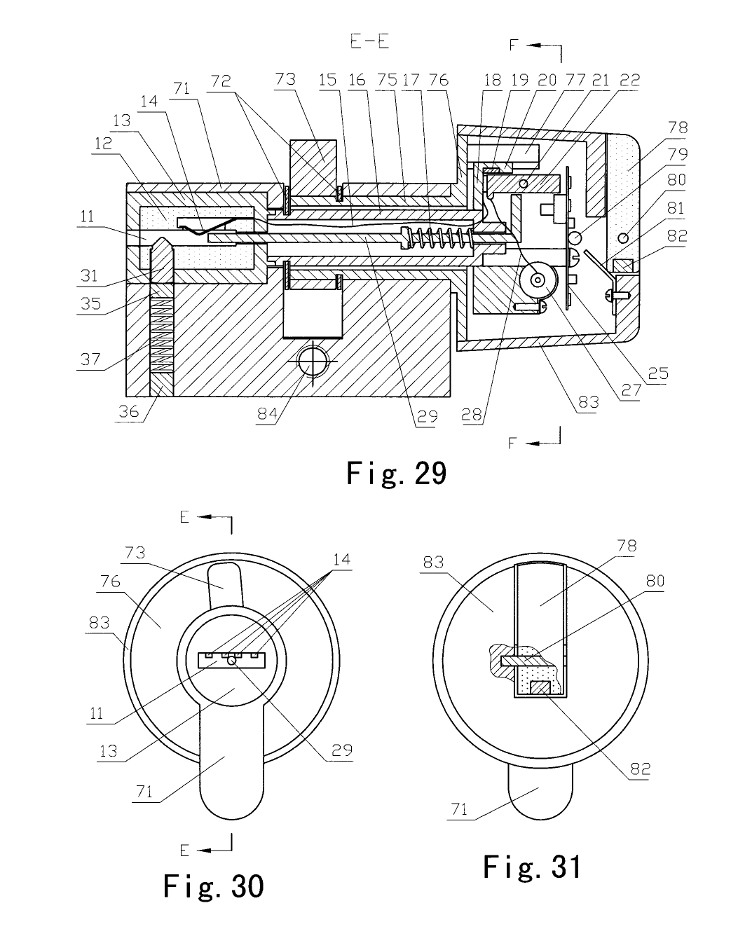

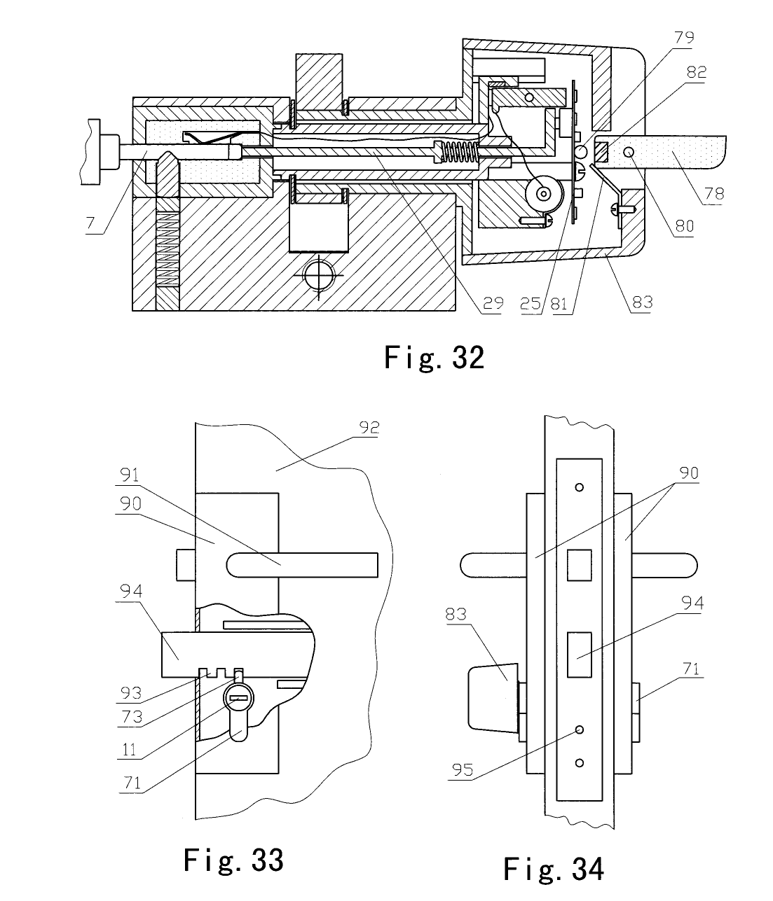

FIG. 29 is a side sectional view of a second embodiment of the electronic lock head of the present invention (i.e. E-E sectional view of FIG. 30). FIG. 30 is a front view of the second embodiment of the electronic lock head of the present invention or a left view of FIG. 29. FIG. 31 is a local right sectional view of FIG. 29. In this embodiment, the outer case 71 and the dial wheel 73 of the electronic lock head are similar to the dial wheel and the gourd-shape outer case of the mechanical lock head of a common door lock, and have lengths and cross-section sizes which are determined with reference to those of bolt insertion type of mechanical locks commonly sold on the market. By combining the outer case 71 of this embodiment with the intelligent rotating lock cylinder device and a driven rotating device of aforesaid embodiments, an electronic lock of this embodiment will be constituted. In FIG. 29, the keyhole unit and cylinder 16 of the aforesaid intelligent rotating lock cylinder device are placed in the empty chamber of the outer case 71. The turntable 18 of the intelligent rotating lock cylinder device of the aforesaid embodiment as well as parts and devices installed on turntable 18 are provided on one side of the outer case 71. The driven rotating device comprises a driven turntable 76, shaft sleeve 75, dial wheel 73 and a cup cover 83. The driven turntable 76 is ring-shaped and is fixed with shaft sleeve 75 together and wraps around the outer surface of cylinder 16. The driven turntable 76 is located between turntable 18 and the outer case 71. Shaft sleeve 75 passes through the outer case 71 and is connected with the dial wheel 73 which is adapted for force transmission and installed in a gap of the outer case 71, for torque transmission outlet. The drive block 77 that can drive the driven turntable 76 to turn together with the intelligent rotating lock cylinder device is fixed on the driven turntable 76. Ring 72 is adapted to limit the intelligent rotating cylinder device and the driven rotating device so that they are not separated from outer case 71. Hole 84 is a fixing hole. In FIG. 29, a bowel-shaped cup cover 83 is fixed on the driven turntable 76. A manual switch that can prevent the key from unlocking in door is installed on the outside of the cup cover 83. This manual switch comprises lever 78, spring 81 and magnet 82. The lever shaft 80 is fixed onto the center of the outer side surface of the cup cover 83. Magnet 82 is fixed onto one end of lever 78 (see FIG. 31). With support of an elastic piece 81, lever 78 can be manually operated to move from the position as indicated in FIG. 29 to the position as indicated in FIG. 32. The schematic circuit diagram of the intelligent rotating lock cylinder device of this embodiment is shown in FIG. 7. Electromagnetic switch device W is a reed switch or a Hall electronic switch, and is installed at the center of the circuit board of the electronic circuit device in the intelligent rotating lock cylinder device. When lever 78 of the above-mentioned manual switch of this embodiment is manually moved to the position as shown in FIG. 32, magnet 82 makes the electromagnetic switch device 79 on the circuit board to be closed, makes short circuit of the base of transistor V shortcut to ground short as shown in FIG. 7, so as to prevent the key from unlocking the door. The manual switch of this embodiment has the same function as that of in-door cutout of common mechanic locks.

The latch bolt structure of door lock matched with this embodiment is shown in FIGS. 33 and 34. FIG. 34 is a left view of FIG. 33. In FIGS. 33 and 34, the bolt insertion type of mechanical door lock comprises a panel 90, a handle 91 and a lock latch bolt 94. The lock latch bolt structure of the mechanical door lock is fixed on the door 92. At the position where the mechanical lock head is installed, the original mechanical lock head may be replaced by the electronic lock head of this embodiment. In this embodiment, screw 95 and hole 84 on the outer case 71 are adapted to fix the lock latch bolt structure. The dial tooth of the dial wheel 73 in this embodiment falls in the tooth slot of the lock latch bolt 94. On the left side of FIG. 34, a cup cover 83 is provided as door lock knob for unlocking indoor. When cup cover 83 is turned in door, in accordance with the structure of FIG. 29 and the aforesaid structure principle, cup cover 83 drives dial wheel 73 to turn together through driven turntable 76 and shaft sleeve 75, thus driving the movement of lock latch bolt 94 to realize unlocking or locking in door.

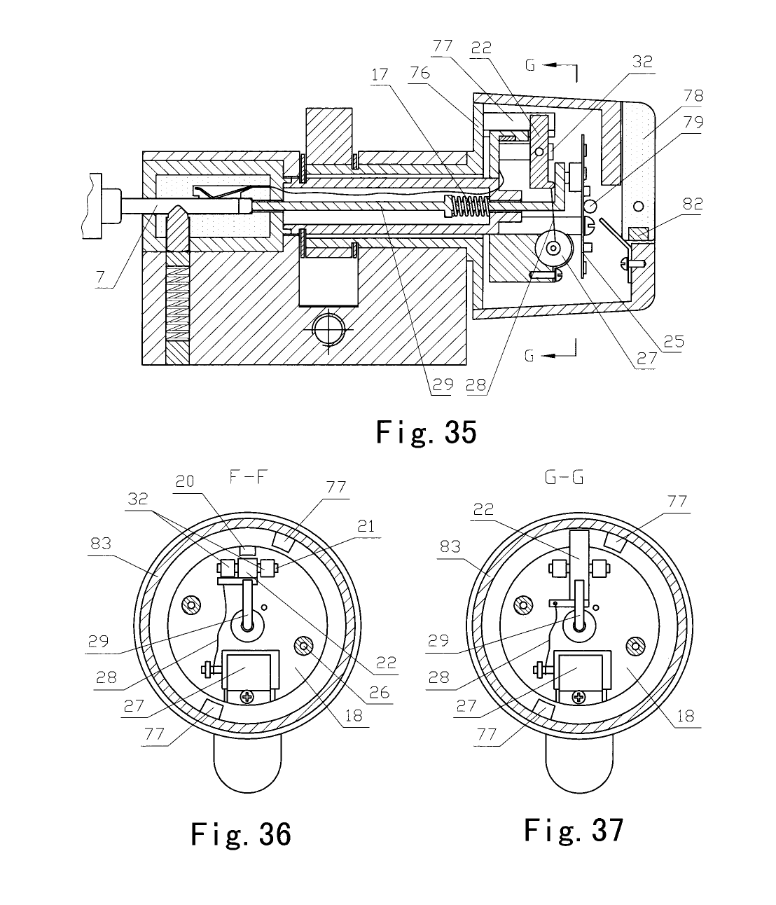

In the case that lever 78 of the manual switch is in a non-open state as shown in FIG. 29, when a key allowed to unlock is inserted into the keyhole 11 of this embodiment (as shown in FIG. 35), electromechanical drive device 27 drives lever 22 under the control of the microprocessor, to change its status from the original status as shown in FIG. 36 to the statuses as shown in FIGS. 35 and 37 (FIG. 36 is a F-F sectional view of FIG. 29; and FIG. 37 is G-G sectional view of FIG. 35). As a result, lever 22 or force transmission clutch device is in an “engaged” status capable of force transmission. At this moment, turning the key will drive the driven turntable 76 and dial wheel 73 to turn together through lever 22 and drive block 77, so as to realize the unlocking or locking movement of the lock latch bolt 94.

In this embodiment, the actions of the movable cylinder 31 of the aforesaid intelligent rotating lock cylinder device and the slide block 35, spring 37 and stopper 36 on the outer case 71 make the key to be inserted or pulled out only when turntable 18 is moved to the positions as shown in FIGS. 29, 35, 36 and 37, so that the manner of inserting or pulling out the key is similar to those of keys of common mechanical locks when locking or unlocking door.

By using the electronic lock head of this embodiment, existing mechanical locks can immediately be upgraded to electronic locks.

1. A self-resetting intelligent rotating lock cylinder device with power supply from a key, comprising:
a keyhole unit, including a keyhole (11) and contact points (14);
a turntable (18) that turns together with the keyhole unit;
an electronic circuit unit (25) that is provided on the turntable (18) and is electrically connected with the contact points (14);
an electromechanical drive unit (27) that is controlled by the electronic circuit unit (25); and
a force transmission clutch unit that is driven by the electromechanical drive unit (27);
wherein a reset push pole (29) is provided within the keyhole (11), and is pushed-in by a head (7) of the key when the key is inserted into the keyhole (11);
wherein the force transmission clutch unit is reset to a non-transmission status when the key is pulled out of the keyhole (11);
wherein a first end of the reset push pole (29) is provided in the keyhole (11), and a second end of the reset push pole (29) passes through the keyhole (11) and is provided on one side of the force transmission clutch unit.

2. The device of claim 1, wherein the second end of the reset push pole (29) has a bent arm.

3. The device of claim 1, further comprising a spring (17) or magnets (38, 39) adapted to reset the reset push pole (29).

4. The device of claim 1, wherein the force transmission clutch unit comprises a lever (22) that is adapted to be driven in different directions by the electromechanical drive unit (27) and the reset push pole (29) respectively.

5. The device of claim 1, wherein the electronic circuit unit comprises a real-time detection circuit that is adapted to detect the movement of the reset push pole (29) at the time the key is inserted into the keyhole.

6. The device of claim 5, wherein the real-time detection circuit comprises a switch (K, 24) which is pushed by the reset push pole (29) to operate.

7. The device of claim 5, wherein the real-time detection circuit comprises a capacitor (C).

8. The device of claim 1, wherein the contact points (14) are provided on a first interior side of the keyhole (11); a movable cylinder (31) is provided on a second interior side of the keyhole (11) and is adapted to limit the key capable of being pulled out at a specific rotational position when the device is fixed into its outer case.

9. The device of claim 1, wherein positions of the contact points (14) on the first interior side correspond to positions of contact points on USB interface of a general purpose computer.

10. A self-reset electronic lock with power supply from a key, comprising: an outer case (41), a lock latch and an intelligent rotating lock cylinder device of claim 1.

11. The self-reset electronic lock of claim 10, wherein the lock latch device comprises:
a drive block (45) provided on the lock latch (42) and
a self-locking lever (43) adapted to prevent the lock latch (42) from sliding when it is locked;
wherein a step (48) is provided on the outer case (41) and is adapted to prevent the self-locking lever (43) from sliding when the lock latch (42) is locked.

12. A self-reset electronic lock head with power supply from a key, comprising: an outer case, a driven rotary device and an intelligent rotating lock cylinder device of claim 1.

13. The self-reset electronic lock head of claim 12, wherein the driven rotary device comprises a driven turntable (76), a shaft sleeve (75) and a dial wheel (73) for force transmission outlet;
wherein one end of the shaft sleeve (75) is fixed on the driven turntable (76) and another end of the shaft sleeve (75) is connected with the dial wheel (73) for force transmission;
wherein a drive block (77) is provided on the driven turntable (76) and is driven by the lever (22).

14. The self-reset electronic lock head of claim 12, wherein the driven rotary device comprises a cup cover (83) served as a knob for indoor unlocking; and a manual switch adapted to prevent the key from unlocking is provided on the cup cover (83).

15. The self-reset electronic lock head of claim 14, wherein the manual switch comprises a lever (78); a magnet (82) is provided on one end of the lever (78); and the electronic circuit unit (25) comprises an electromagnetic switch device (W, 79) adapted to prevent the key from unlocking under the effect of the magnet (82).

16. A self-reset electronic lock head of claim 12, wherein the driven rotary device comprises a driven turntable (53) provided inside the outer case (51); and a pole (54) for force transmission outlet and a drive block (52) driven by a lever (22) are provided on the driven turntable (53).

17. An electronic key matched with a self-reset intelligent rotating lock cylinder device with power supply from the key and a matched lockset, comprising:
a key head (7);
contact points (1) provided on the key head (7);
an electronic circuit device (5) electrically connected with the contact points (1); and
an outer case (3);
wherein, the electronic circuit device (5) comprises a power supply (6); part of the outer surface of the key head (7) is wrapped with a metal sleeve (2) which is adapted to increase a push force of a reset push pole (29) in a keyhole (11) of the rotating lock cylinder device when the key head (7) is inserted into the keyhole (11), and to strengthen a torque force of the rotating lock cylinder device; and all of the contact points (1) are exposed to the outside of the metal sleeve (2).

18. The electronic key of claim 17, wherein a U-shaped gap is provided at one end of the metal sleeve (2); and all of the contact points (1) are exposed within the U-shaped gap.

19. The electronic key of claim 17, wherein a through hole or a blind hole (8) is provided on the key head (7).

20. The electronic key of claim 17, wherein positions of the contact points (7) correspond to positions of contact points on USB interface of a general purpose computer.

21. The electronic key of claim 17, wherein the power supply (6) is a chargeable battery.
